(19) United States
(12) Patent Application Publication
(10) Pub. No.: US 2016/0117667 A1
(43) Pub. Date: Apr. 28, 2016

(54) DIVIDED PAYMENT METHOD, APPARATUS AND SYSTEM

(71) Applicant: SK PLANET CO., LTD., Seongnam-si, Gyeonggi-do (KR)

(72) Inventors: Kichon KANG, Seoul (KR); Jaehyung HUH, Seongnam-si, Gyeonggi-do (KR)

(21) Appl. No.: 14/894,853

(22) PCT Filed: Dec. 19, 2014
(86) PCT No.: PCT/KR2014/012579

§ 371 Date: Nov. 30, 2015

(30) Foreign Application Priority Data
Mar. 21, 2014 (KR) 10-2014-0033301

(51) Int. Cl. G06Q 20/32; G06Q 20/42; G06Q 20/22

(52) U.S. Cl. CPC G06Q 20/327; G06Q 20/29; G06Q 20/42

(57) ABSTRACT

A divided payment method and an apparatus and system for the method. According to this invention, a mobile communication device receives virtual payment information of a person participating in divided payment from at least one another mobile communication device or a payment service apparatus. After creating divided payment request information by using own payment information and the received virtual payment information, the mobile communication device requests the divided payment by transmitting the created divided payment request information to the payment device. Therefore, even though only one person among several persons participating in mobile payment transacts payment, the divided payment is performed for all persons. Also, since payment information of a person participating in the divided payment is offered in the form of virtual payment information to the mobile communication device transacting payment, it is possible to remove danger of misuse due to offering payment information to other person.

### TECHNICAL FIELD

The present invention relates to a mobile payment system and method, and more particularly to a divided payment method, as well as an apparatus and system for the method, for, in case there is a need to divide up mobile payment among a plurality of persons, allowing a mobile communication device of a transactor who will transact mobile payment to be offered virtual payment information of the other persons, allowing the mobile communication device of the transactor to offer payment information of the plurality of persons to a payment device for divided payment, and thereby relieving inconvenience of requiring each person to perform mobile payment individually.

### BACKGROUND ART

Recently mobile communication devices such as a portable phone have been popularized as necessaries. Now such mobile communication devices are offering, as additional functions, functions (e.g., camera, MP3, memo functions, etc.) of various portable digital devices in addition to an inherent function such as a voice call.

Considering that users always carry their mobile communication devices as if carrying a wallet, a mobile payment function using a mobile communication device has been developed as one of additional functions.

A user of a mobile communication device having a mobile payment function may not need to separately carry a credit card, a check card, etc. and also can use advantageously quick and simple payment in comparison with the existing physical card.

This mobile payment may be based on cloud technology or utilize short range communication technology such as NFC (Near Field Communication). A certain device available for mobile payment is allowed to perform just one payment for a single payment amount by utilizing payment information, e.g., card information, contained therein.

Meanwhile, payment may be performed by a single person or by several persons who divide up a payment amount.

In the former case, since a single person pays the entire payment amount, no inconvenience occurs due to payment.

In the latter case, since several persons divide up payment, any inconvenience is caused even in case of mobile payment like case of using a physical card and also too much time is spent on payment. For example, in case ten persons divide up a payment amount for mobile payment, each individual person should wait his or her turn and then pay an allotted amount by touching his or her mobile communication device on a payment device. This offsets advantages of mobile payment.

### DISCLOSURE

### Technical Problem

Accordingly, one object of the present invention is to provide a divided payment method, apparatus and system for performing divided payment for all persons participating in mobile payment even though only one person among such persons transacts payment.

Another object of the present invention is to provide a divided payment method, apparatus and system for, in case there is a need to divide up mobile payment among a plurality of persons, allowing a mobile communication device of a transactor who will transact mobile payment to be offered virtual payment information of the other persons, allowing the mobile communication device of the transactor to offer payment information of the plurality of persons to a payment device for divided payment, and thereby relieving inconvenience of requiring each person to perform mobile payment individually.

### Technical Solution

In order to accomplish the above objects, the present invention provides a mobile communication device that includes a communication unit and a control unit. Herein, the communication unit is configured to perform communication with at least one another mobile communication device, a payment service apparatus, or a payment device. Additionally, the control unit is configured to create divided payment request information by using own payment information and the received virtual payment information when virtual payment information of a person participating in divided payment is received from the at least one another mobile communication device or the payment service apparatus through the communication unit, and to request the divided payment by transmitting the created divided payment request information to the payment device through the communication unit.

In the mobile communication device according to this invention, the communication unit may include a short range communication unit configured to perform short range communication with the another mobile communication device or the payment device, and a wired/wireless communication unit configured to perform communication with the payment service apparatus through a communication network. Herein, the control unit may be further configured to receive virtual payment information through short range communication with the another mobile communication device or from the payment service apparatus through the communication network, and to transmit the divided payment request information to the payment device through short range communication.

In the mobile communication device according to this invention, the control unit may be further configured to calculate a payment amount for each individual user participating in divided payment with regard to a total payment amount, and to create divided payment request information that includes the calculated payment amount for each user, own payment information, and the received virtual payment information.

In the mobile communication device according to this invention, the control unit may be further configured to calculate the payment amount for each user by equally dividing the total payment amount by the number of users participating in divided payment or according to an allotted ratio of payment amount for each user.

In the mobile communication device according to this invention, the divided payment request information may further include a phone number of the mobile communication device and a phone number of the another mobile communication device.

In the mobile communication device according to this invention, the virtual payment information may be single-use payment information corresponding to actual payment information of the another mobile communication device.

Additionally, the present invention provides a payment service apparatus that includes a service communication unit and a service control unit. The service communication unit is configured to perform communication with a payment device, a mobile communication device of a transactor who transacts divided payment, and at least one another mobile communication device which participates in the divided payment. The service control unit is configured to create and deliver virtual payment information to the another mobile communication device when virtual payment request information is received from the another mobile communication device through the service communication unit, to approve divided payment by performing the divided payment according to divided payment request information when the divided payment request information including actual payment information of the mobile communication device and the virtual payment information is received from the payment device, and to transmit divided payment approval information to the payment device and a plurality of mobile communication devices participating in the divided payment.

Also, the present invention provides a divided payment system that includes a payment service apparatus, a payment device, and a mobile communication device. The payment service apparatus is configured to transmit virtual payment information through a communication network and to offer a payment service. The payment device is configured to perform payment by interworking with the payment service apparatus connected through the communication network when payment request information is received from the mobile communication device. The mobile communication device is configured to create divided payment request information by using own payment information and the virtual payment information when the virtual payment information of a person participating in divided payment is received from at least one another mobile communication device or the payment service apparatus.

The divided payment system according to this invention may further include at least one another mobile communication device configured to receive the virtual payment information from the payment service apparatus through the communication network, and to transmit the received virtual payment information to the mobile communication device through short range communication.

In addition, the present invention provides a divided payment method that includes steps of, at a mobile communication device, receiving virtual payment information of a person participating in divided payment from at least one another mobile communication device or a payment service apparatus, at the mobile communication device, creating divided payment request information by using own payment information and the received virtual payment information, and at the mobile communication device, requesting the divided payment by transmitting the created divided payment request information to the payment device.

In the divided payment method according to this invention, the receiving step may include, at the another mobile communication device, requesting and receiving the virtual payment information from the payment service apparatus, and at the mobile communication device, receiving the virtual payment information from the another mobile communication device.

In the divided payment method according to this invention, the receiving step may include, at the mobile device, receiving the virtual payment information from the another mobile communication device through short range communication.

In the divided payment method according to this invention, the receiving step may include, at the another mobile communication device, requesting the payment service apparatus to transmit the virtual payment information to the mobile communication device, and at the mobile communication device, receiving the virtual payment information from the payment service apparatus.

In the divided payment method according to this invention, the requesting step may include, at the another mobile communication device, transmitting a phone number of the mobile communication device to the payment service apparatus, and also the receiving step may include, at the payment service apparatus, transmitting the virtual payment information to the mobile communication device by using the phone number of the mobile communication device.

In the divided payment method according to this invention, the requesting step may include, at the mobile communication device, transmitting the divided payment request information to the payment device through short range communication.

The divided payment method according to this invention may further include step of, after the requesting step, at the mobile communication device, deleting the received virtual payment information.

The divided payment method according to this invention may further include step of, after the requesting step, at the mobile communication device, receiving divided payment approval information from the payment service apparatus.

The divided payment method according to this invention may further include step of, after the requesting step, at the mobile communication device and the another mobile communication device, respectively receiving divided payment approval information from the payment service apparatus.

Additionally, the present invention provides a computer-readable storage medium recording thereon a program for executing the divided payment method mentioned above.

### Advantageous Effects

According to the present invention, since divided payment is performed for all persons participating in mobile payment even though only one person among such persons transacts payment, any inconvenience that a plurality of persons have to wait their turns and then perform payment respectively can be relieved.

Namely, in case there is a need to divide up mobile payment among a plurality of persons, this invention allows a mobile communication device of a transactor who will transact mobile payment to be offered virtual payment information of the other persons, and also allows the mobile communication device of the transactor to offer payment information of the plurality of persons to a payment device for divided payment. It is therefore possible to relieve inconvenience of requiring each person to perform mobile payment individually and also reduce time spent on payment.

Additionally, by offering virtual payment information capable of single-use when payment information of other persons is offered to the mobile communication device of a transactor, this invention can remove danger of misuse due to offering payment information to other person.

### DESCRIPTION OF DRAWINGS

FIG. 1 is a block diagram illustrating a divided payment system according to an embodiment of the present invention.

FIG. 2 is a block diagram illustrating main elements of a mobile communication device shown in FIG. 1.

FIG. 3 is a block diagram illustrating main elements of a payment service apparatus shown in FIG. 1.

FIG. 4 is a flow diagram illustrating a divided payment method according to an embodiment of the present invention.

FIG. 5 is a flow diagram illustrating a divided payment method according to another embodiment of the present invention.

### MODE FOR INVENTION

Hereinafter, embodiments of the present invention will be described with reference to the accompanying drawings. In this disclosure, well known techniques or elements may not be described or illustrated in detail to avoid obscuring the subject matter of the present invention. The expression “first”, “second”, or the like used herein may be used for distinguishing various elements from the others but does not limit such elements.

Also, through the whole drawings, elements having similar functions or operations will use the same reference numerals.

In addition, a mobile communication device of this invention may be implemented in various forms. For example, a mobile communication device disclosed herein may employ a smart phone, a tablet PC, a personal digital assistant (PDA), a portable multimedia player (PMP), an MP3 player, or the like. Further, any device capable of transmitting and receiving information through a communication network or short range communication may be applied to a mobile communication device of this invention.

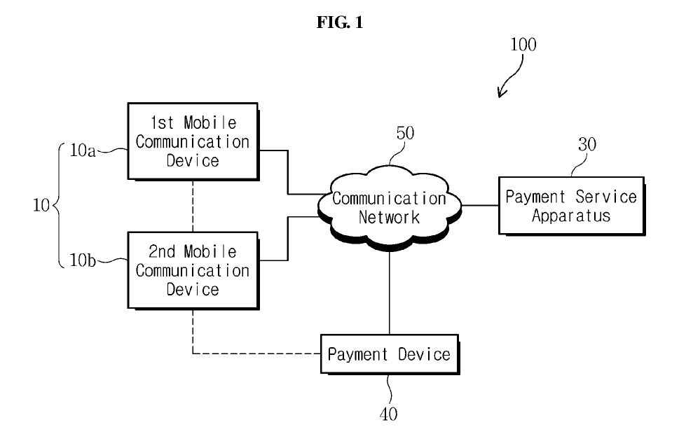

Now, a divided payment system according to an embodiment of this invention will be described with reference to FIG. 1. FIG. 1 is a block diagram illustrating a divided payment system according to an embodiment of the present invention.

Referring to FIG. 1, the divided payment system 100 according to this embodiment is a mobile payment system that allows mobile payment using a mobile communication device 10. Namely, in case there is a need to divide up payment among several persons, the mobile communication device 10 of a specific transactor who will transact payment is offered virtual payment information of the other persons. For divided payment, the mobile communication device 10 of the transactor simultaneously offers payment information of several persons to a payment device 40.

Therefore, the divided payment system 100 according to this embodiment may be a payment system that can relieve inconvenience of requiring each person to perform mobile payment individually.

The divided payment system 100 according to this embodiment may be configured to include a plurality of mobile communication devices 10, a payment service apparatus 30, and a payment device 40 which are connected to each other by means of a communication network 50.

The communication network 50 is a communication medium for connecting the mobile communication device 10, the payment service apparatus 30, and the payment device 40 so as to transmit and receive information. The communication network 50 may use a wireless communication scheme such as WLAN (Wireless LAN), Wi-Fi, Wibro, Wimax, and HSDPA (High Speed Downlink Packet Access), or a wired communication scheme such as Ethernet, xDSL (ADSL, VDSL), HFC (Hybrid Fiber Coaxial Cable), FTTC (Fiber To The Curb), and FTTH (Fiber To The Home). Also, the communication network 50 may use any other communication scheme which is well known or will be developed.

The mobile communication device 10 may perform mobile payment by interworking with the payment service apparatus 30 and the payment device 40. Namely, the mobile communication device 10 is a device that has a mobile payment function and is used by a customer (person) who purchases and pays for an article or a service through mobile payment. The mobile communication device 10 stores payment information required for mobile payment and may offer the stored payment information to the payment device 40 or the payment service apparatus 30.

The mobile communication device 10 may offer payment information to the payment device 40 through the communication network 50 or short range communication. Here, short range communication may use, but not limited to, Bluetooth, infrared communication, Wi-Fi, NFC (Near Field Communication), or the like.

The mobile communication device 10 may request virtual payment information from the payment service apparatus 30 through the communication network 50 and then receive the requested information.

The mobile communication device 10 includes the first mobile communication device 10a used by a transactor who transacts divided payment, and the other mobile communication device, i.e., the second mobile communication device 10b, used by customers who participate in divided payment.

According to this embodiment, the first mobile communication device 10a receives, from the second mobile communication device(s) 10b or the payment service apparatus 30, virtual payment information of a person who will participate in divided payment. Then the first mobile communication device 10a creates divided payment request information by using both payment information thereof and the received virtual payment information, and requests divided payment by transmitting the created divided payment request information to the payment device 40.

The payment information of the first mobile communication device contained in the divided payment request information may be actual payment information or virtual payment information.

The divided payment request information may contain a payment amount, or an allotted ratio thereof, of each user who participates in divided payment, in addition to the payment information of the first mobile communication device and the received virtual payment information. Also, the divided payment request information may further contain a phone number of the mobile communication device of each user who participates in divided payment.

The second mobile communication device 10b may request virtual payment information from the payment service apparatus 30 through the communication network 50 and then receive the requested information. The second mobile communication device 10b transmits the received virtual payment information to the first mobile communication device 10a. Through the communication network 50 or short range communication, the second mobile communication device 10b may transmit such virtual payment information to the first mobile communication device 10a.

Alternatively, the second mobile communication device 10b may request the payment service apparatus 30 to transmit virtual payment information to the first mobile communication device 10a. Then the first mobile communication device 10a may receive virtual payment information of the second mobile communication device 10b from the payment service apparatus 30. At this time, the second mobile communication device 10b may offer a phone number of the first mobile communication device 10a to the payment service apparatus 30 so that the payment service apparatus 30 can transmit virtual payment information to the first mobile communication device 10a.

The payment service apparatus 30 offers a payment service by interworking with the mobile communication device 10 and the payment device 40 via the communication network 50. Particularly, the payment service apparatus 30 may create virtual payment information at the request of the second mobile communication device 10b and then offer the created information to the first or second mobile communication device 10b.

Virtual payment information may be single-use imaginary payment information corresponding to actual payment information of the second mobile communication device 10b. This actual payment information may contain information about a credit card, a debit card, automatic transfer, etc. available for payment. Since there is a possibility of misuse if actual payment information is offered to other person, i.e., the first mobile communication device 10a, virtual payment information is offered instead of actual payment information. After offered to the first mobile communication device 10a, virtual payment information is deleted from the first mobile communication device 10a when a predetermined time elapses or when payment approval information is offered to the first mobile communication device 10a. Of course, in case payment approval information is offered to the second mobile communication device 10b, the second mobile communication device 10b may delete its own virtual payment information.

The payment service apparatus 30 is an apparatus for offering a payment service such as mobile payment and may include a service server and a payment server of a financial institution (e.g., a credit-card company, a bank, etc.). Here, the service server requests a payment approval from a payment server on the basis of payment information, e.g., card information, of each user participating in divided payment when the payment device 40 requests a divided payment approval. Then the service server receives a payment approval for each user and delivers the received payment approval to the payment device 40 or the mobile communication device 10. Additionally, the payment server is connected with the payment device 40 and the service server through VAN (Value Added Network). If a divided payment request for each user is received from the service server, the payment server performs a predetermined approval procedure and returns an approval result for each user to the service server.

The payment service apparatus 30 may be implemented as one or more servers that operate in a server-based computing scheme or in a cloud scheme. In particular, information transmitted or received through the divided payment system 100 may be offered through a cloud computing function that may be permanently stored in a cloud computing apparatus on the internet. Here, cloud computing refers to technology for servicing on-demand IT (Information Technology) resources, virtualized using internet technology, such as hardware (server, storage, network, etc.), software (database, security, web server, etc.), service, data, and the like to digital terminals such as a desktop, a tablet computer, a notebook, a netbook, a smart phone, and the like. In this embodiment, all kinds of information transmitted or received between the mobile communication devices 10 and the payment service apparatus 30 may be stored in a cloud computing apparatus on the internet and retrieved anywhere and at any time.

The payment device 40 is a device that performs payment by interworking with the payment service apparatus 30 connected through the communication network 50 when payment request information is received from the mobile communication device 10. For example, the payment device 40 may be a POS (Point Of Sales) device, which combines functions of a cash register with those of a computer terminal, thereby calculating a sales volume as well as collecting and processing various types of information and data required for retail management. Also, the payment device 40 may be a device having a combination of a PC and a credit card machine and storing data such as an article name or price, or a device such as CAT (Credit Authorization Terminal) for performing payment.

According to the present invention, since divided payment is performed for all persons participating in payment even though only one person among such persons transacts mobile payment, any inconvenience that a plurality of persons have to wait their turns and then perform payment respectively can be relieved.

Namely, in case there is a need to divide up mobile payment among a plurality of persons, the first mobile communication device 10a is offered virtual payment information of the other persons, and offers payment information of the plurality of persons to the payment device 40 for divided payment. It is therefore possible to relieve inconvenience of requiring each person to perform payment individually by using the first and second mobile communication devices 10b and also reduce time spent on payment.

Additionally, by offering virtual payment information capable of single-use when payment information of other persons is offered to the first mobile communication device 10a, this invention can remove danger of misuse due to offering payment information to other person.

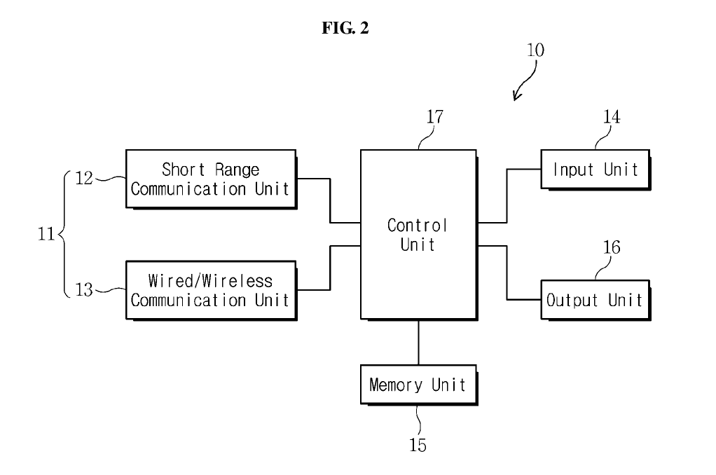

Now, the mobile communication device 10 of the divided payment system 100 will be described with reference to FIGS. 1 and 2. FIG. 2 is a block diagram illustrating main elements of the mobile communication device 10 shown in FIG. 1.

Referring to FIGS. 1 and 2, the mobile communication device 10 according to this embodiment includes a communication unit 11 and a control unit 17 and may further include an input unit 14, a memory unit 15, and an output unit 16.

The communication unit 11 performs communication with at least one of other mobile communication devices, the payment service apparatus 30, or the payment device 40. The communication unit 11 may include a short range communication unit 12 and a wired/wireless communication unit 13.

The short range communication unit 12 transmits or receives information to or from other mobile communication device or the payment device 40 through short range communication. The short range communication unit 12 may transmit or receive data in the manner of Bluetooth and may also use other various short range communication techniques (infrared communication, Wi-Fi, NFC, etc.). The short range communication unit 12 may receive virtual payment information from other mobile communication devices and then transmit the received information to the payment device 40.

The wired/wireless communication unit 13 may include an element for transmitting or receiving data by accessing the communication network 50, e.g., the mobile communication network. The mobile communication device 10 may access the mobile communication network such as WCDMA, LTE, LTE-A, or the like through the wired/wireless communication unit 13 and then offer various services such as voice/video call services, SMS (Short Message Service), MMS (Multimedia Message Service), IM (Instant Messaging) service, SNS (Social Network Service), and the like through the mobile communication network. Additionally, for a divided payment service according to this embodiment, the wired/wireless communication unit 13 may transmit or receive information (e.g., request information for virtual payment information, virtual payment information, request information for divided payment approval, divided payment approval information, etc.) associated with a payment transaction of the payment service apparatus 30.

The input unit 14 is an element for manipulating the mobile communication device 10 and for entering a data input. In response to user's manipulations, the input unit 14 creates a user input signal associated with various kinds of information, setting of various functions, and a function control of the mobile communication device 10, and then delivers the created signal to the control unit 17. Particularly, the input unit 14 may deliver a user input signal corresponding to a payment request for a divided payment service to the control unit 17.

The input unit 14 may a key input member such as a keyboard or a keypad, a touch input member such as a touch sensor or a touch pad, a voice input member, a gesture input member having at least one of a gyro sensor, a geomagnetic sensor, an acceleration sensor, a proximity sensor and a camera, and other various input members which may be available in the future.

The memory unit 15 may store temporarily or permanently programs required for the operation of the mobile communication device 10 and various kinds of data created during the execution of such programs. The memory unit 15 may include mainly a program region and a data region. The program region stores an operating system (OS) for booting the mobile communication device 10 and one or more programs or applications implemented for performing specific functions. Particularly, the program region may store a divided payment program that creates divided payment request information by using virtual payment information received from other mobile communication devices and its own payment information so as to perform divided payment. The data region temporarily stores data created during use of the mobile communication device 10, for example, article information or virtual payment information received by the mobile communication device 10. Particularly, the data region may store actual payment information required for mobile payment. This actual payment information may be information having the form of a mobile card, and may have information about one or more cards to be selectable for payment. For example, in case of being based on a credit card, actual payment information may contain a card number and a personal identification number (PIN).

The memory unit 15 may include, but not limited to, storage media such as flash memory, hard disk, multimedia card micro-type memory (e.g., SD or XD memory, etc.), RAM, ROM, and the like.

Although this embodiment focuses on configuration that the memory unit 15 stores actual payment information, divided payment program, contents, etc. required for mobile payment, this is exemplary only and not to be construed as a limitation. Alternatively or additionally, the above may be stored in a cloud computing device that interworks with the mobile communication device 10 and the payment service apparatus 30.

The output unit 16 is an element for outputting information about the state and result of operations generated during the execution of functions of the mobile communication device 10. In this disclosure, the output unit 16 refers to both a display member for visually outputting information and an audio output member for audibly outputting information. As the display member, the output unit 16 may be formed of LCD (Liquid Crystal Display), TFT-LCD (Thin Film Transistor LCD), OLED (Organic Light Emitting Diodes), LED, AMOLED (Active Matrix OLED), flexible display, 3-dimensional display, touch screen, or the like.

In this embodiment, the output unit 16 may output information required for divided payment, e.g., its own payment information, virtual payment information of other mobile communication devices, divided payment approval information, etc., under the control of the control unit 17. Also, the output unit 16 may output GUI (Graphic User Interface) associated with divided payment.

The control unit 17 is an element for controlling the overall operation of the mobile communication device 10 and may be implemented as a combination of hardware such as a processor and software such as at least one routine or program loaded and executed by the processor. The control unit 17 may construct an execution environment by loading the OS program and then execute one or more routines and programs in response to a user's input signal received through the input unit 14 so as to perform a particular function.

In particular, in case there is a need to divide up payment among several persons, the control unit 17 may control the operation of divided payment. Namely, the control unit 17 receives virtual payment information of persons participating in divided payment from other mobile communication device(s) or the payment service apparatus 30 through the communication unit 11. Using the received virtual payment information and its own payment information, the control unit 17 creates divided payment request information. Then the control unit 17 transmits the created divided payment request information to the payment device 40 through the communication unit 11 so as to request divided payment.

At this time, the control unit 17 may further receive information about an allotted payment amount, a device phone number, or the like in addition to virtual payment information from the second mobile communication device 10b through the communication unit 11. For example, the control unit 17 may receive such information from the second mobile communication device 10b through the short rage communication unit 12.

The control unit 17 may retrieve its own payment information stored in the memory unit 15 before or after receiving virtual payment information from the second mobile communication device 10b. Then, using the received virtual payment information and the retrieved payment information, the control unit 17 may create divided payment request information. This divided payment request information may contain phone numbers of the mobile communication devices 10 of users who participate in divided payment, namely, phone numbers of the first and second mobile communication devices 10a and 10b.

The control unit 17 may calculate a payment amount for each individual user participating in divided payment with regard to a total payment amount, and create divided payment request information that includes the calculated payment amount for each user, its own payment information, and the received virtual payment information. At this time, the control unit 17 may calculate such a payment amount for each user by equally dividing a total payment amount by the number of users participating in divided payment or according to an allotted ratio of payment amount of each user. User payment amount information refers to information about each payment amount allotted to each user with regard to a total payment amount.

For example, when divided payment request information is created, user payment amount information may be received together with virtual payment information.

Alternatively, user payment amount information may be entered through the input unit 14. In this case, the control unit 17 may create divided payment request information by inserting each allotted payment amount information into its own payment information and virtual payment information.

Alternatively, when divided payment request information is created, the control unit 17 may receive a total payment amount through the communication unit 11 or the input unit 14. In this case, the control unit 17 may calculate each individual payment amount by using the total payment amount and the number of users participating in divided payment of the total payment amount, and create divided payment request information that contains the calculated individual payment amount, its own payment information, and the received virtual payment information. Here, individual payment amount may be set to be calculated by equally dividing the total payment amount by the number of persons, i.e., the number of its own payment information and the received virtual payment information, or set to be calculated according to different ratios of individual payment amounts allotted to respective users.

The control unit 17 may receive virtual payment information from other mobile communication device, receiving the virtual payment information from the payment service apparatus 30, through the communication unit 11, e.g., the short range communication unit 12. Alternatively, the control unit 17 may receive such virtual payment information of other mobile communication device directly from the payment service apparatus 30 through the communication unit 11, e.g., the wired/wireless communication unit 13.

The control unit 17 may transmit divided payment request information to the payment device 40 through the short range communication unit 12.

If divided payment approval information is received from the payment service apparatus 30, the control unit 17 deletes the received virtual payment information from the memory unit 15. In this case, the control unit 17 may delete the virtual payment information after the divided payment approval information is received or when a predetermined time elapses even though the divided payment approval information is not received.

Meanwhile, for creating divided payment request information, the control unit 17 may use, as its own payment information, one of actual payment information and virtual payment information. In case of using actual payment information as its own payment information, the control unit 17 may retrieve such information from the memory unit 15. In case of using virtual payment information as its own payment information, the control unit 17 may request such information from the payment service apparatus 30 through the communication unit 11.

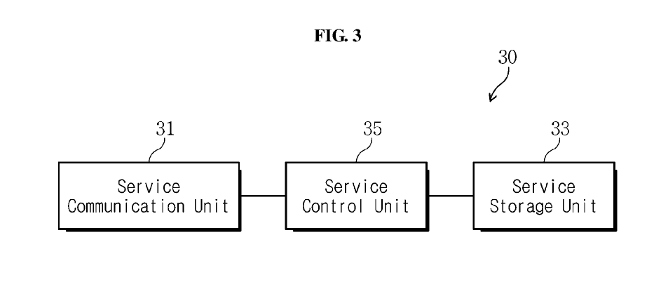

Now, the payment service apparatus 30 of the divided payment system 100 will be described with reference to FIGS. 1 and 3. FIG. 3 is a block diagram illustrating main elements of the payment service apparatus 30 shown in FIG. 1.

Referring to FIGS. 1 and 3, the payment service apparatus 30 according to this embodiment includes a service communication unit 31 and a service control unit 35 and may further include a service storage unit 33.

The service communication unit 31 performs communication with the first mobile communication device 10a, the second mobile communication device(s) 10b, and the payment device 40 through the communication network 50. The service communication unit 31 may receive a request for transmission of virtual payment information from the second mobile communication device 10b. The service communication unit 31 may receive divided payment request information through the payment device 40. Under the control of the service control unit 35, the service communication unit 31 may transmit divided payment approval information to the first mobile communication device 10a, the second mobile communication device(s) 10b, or the payment device 40.

The service control unit 35 performs the overall control of the payment service apparatus 30. The service control unit 35 may perform various controls associated with divided payment.

Namely, when a request for transmitting virtual payment information of the second mobile communication device 10b is received through the service communication unit 31, the service control unit 35 may create virtual payment information based on actual payment information of the second mobile communication unit 10b and transmit the created information to the second mobile communication unit 10b.

Alternatively, when a request for transmitting virtual payment information of the second mobile communication device 10b to the first mobile communication device 10a is received through the service communication unit 31, the service control unit 35 may create virtual payment information based on actual payment information of the second mobile communication unit 10b and transmit the created information to the first mobile communication unit 10a. In this case, the service control unit 35 may notify the second mobile communication unit 10b that virtual payment information is transmitted to the first mobile communication unit 10a.

Additionally, when divided payment request information that contains actual payment information of the first mobile communication device 10a and virtual payment information of the second mobile communication device(s) 10b is received from the payment device 40 through the service communication unit 31, the service control unit 35 may approve divided payment by performing divided payment according to the received divided payment request information and then transmit divided payment approval information to the first mobile communication device 10a, the second mobile communication device(s) 10b, and the payment device 40.

At this time, based on actual payment information, virtual payment information, and one of payment information of each user and an allotted ratio of payment amount of each user, contained in the divided payment request information, the service control unit 35 may perform divided payment for persons who participate in divided payment.

The service storage unit 33 may store various kinds of information used for divided payment under the control of the service control unit 35. Also, the service storage unit 33 stores a program for creating virtual payment information on the basis of actual payment information and performing divided payment by interworking with the payment device 40 on the basis of actual payment information and virtual payment information.

The service storage unit 33 may be a storing space in the divided payment system 100 or a separate data storage device which resides at the outside of the divided payment system 100 and has the ability to transmit or receive data to or from the payment service apparatus 30.

Although this description and drawings illustrate exemplary device elements, the subject matters and functional operations disclosed herein may be implemented by different type digital electronic circuits or implemented by computer software, firmware or hardware including a structure disclosed herein and structural equivalent thereof, or any combination thereof. The subject matters disclosed herein may be implemented by at least one computer program product, namely at least one module regarding computer program commands encoded on a program storage medium so as to control the operation of a device according to this invention or allow execution thereby. A computer-readable medium may be a machine-readable storage device, a machine-readable storage board, a memory device, a machine-readable composition of material affecting wave-type signaling, or a combination thereof.

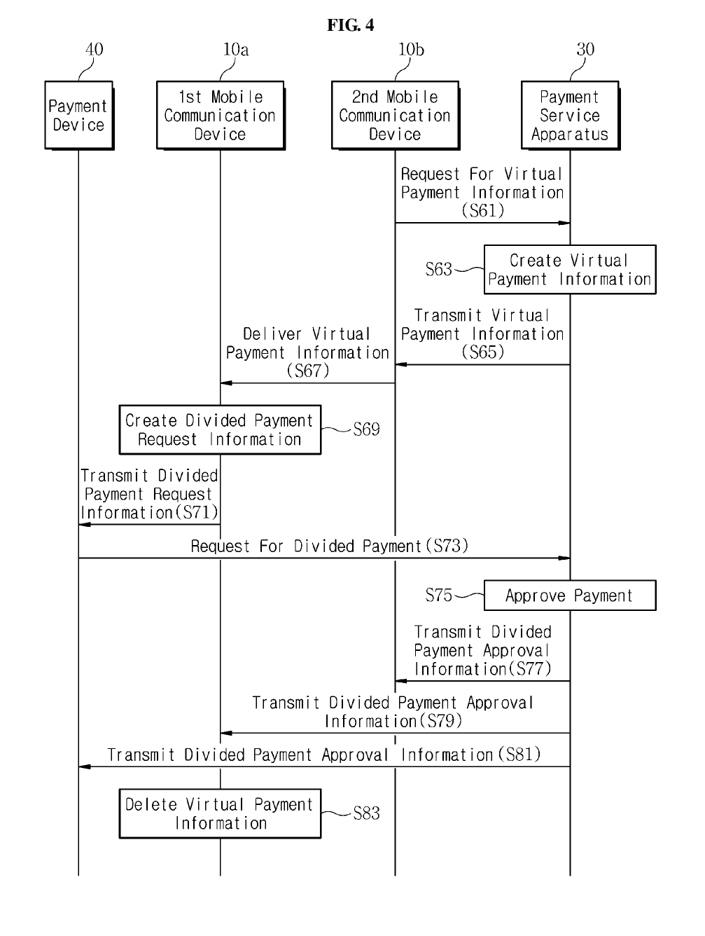

Now, a divided payment method using the above-discussed divided payment system 100 according to an embodiment will be described with reference to FIGS. 1 to 4. FIG. 4 is a flow diagram illustrating a divided payment method according to an embodiment of the present invention.

At the outset, in case there is a need to divide up payment among a plurality of persons through mobile payment, a specific transactor who will transact payment is determined from among such persons. As mentioned above, a mobile communication device of the transactor is referred to as the first mobile communication device 10a, and a mobile communication device of the other persons is referred to as the second mobile communication device 10b.

At step S61, the second mobile communication device 10b requests virtual payment information from the payment service apparatus 30 through the communication network 50. At this step, the second mobile communication device 10b may transmit actual payment information to be used for divided payment to the payment service apparatus 30.

Next, at step S63, the payment service apparatus 30 creates virtual payment information to be transmitted to the second mobile communication device 10b. At this step, the payment service apparatus 30 creates virtual payment information on the basis of actual payment information of the second mobile communication device 10b.

Next, at step S65, the payment service apparatus 30 transmits the created virtual payment information to the second mobile communication device 10b through the communication network 50.

Next, at step S67, the second mobile communication device 10b delivers the received virtual payment information to the first mobile communication device 10a. Such virtual payment information may be delivered from the second mobile communication device 10b to the first mobile communication device 10a through the communication network 50 or short range communication.

Next, at step S69, the first mobile communication device 10a creates divided payment request information by using payment information thereof and the received virtual payment information. At this step, the divided payment request information may contain information about phone numbers of the first and second mobile communication devices 10b. Also, the payment information of the first mobile communication device 10a contained in the divided payment request information may be actual payment information.

Although the first mobile communication device 10a uses actual payment information as its own payment information in this embodiment, the first mobile communication device 10a may use its own virtual payment information received from the payment service apparatus 30.

Next, at step S71, the first mobile communication device 10a transmits divided payment request information to the payment device 40 through short range communication.

Next, at step S73, the payment device 40 transmits the received divided payment request information to the payment service apparatus 30 through the communication network 50 so as to request divided payment.

Next, at step S75, the payment service apparatus 30 performs divided payment, based on the received divided payment request information, and thereby approves payment. Namely, the payment service apparatus 30 approves payment after performing divided payment according to a payment amount, or an allotted ratio thereof, of each user who participates in divided payment, contained in the divided payment request information.

If any payment information incapable of performing payment is contained, the payment service apparatus 30 may refuse the divided payment request.

Next, at steps S77, S79 and S81, the payment service apparatus 30 may transmit divided payment approval information to each of the second mobile communication device 10b, the first mobile communication device 10a, and the payment device 40 all of which participate in divided payment.

Although the divided payment approval information is transmitted to each of the second mobile communication device 10b, the first mobile communication device 10a, and the payment device 40 in this embodiment, this is exemplary only and not to be construed as a limitation. The divided payment approval information may be offered to the payment device 40 only, and users of the first and second mobile communication devices 10b may check the divided payment approval information through a screen or receipt outputted at the payment device 40. Alternatively, the divided payment approval information may be offered only to the payment device 40 and the first mobile communication device 10a both of which participate in actual payment. Also, the divided payment approval information may be offered to the first mobile communication device 10a through the payment device 40.

Additionally, at step S83, the first mobile communication device 10a receiving the divided payment approval information deletes the virtual payment information received from the second mobile communication device 10b. Although not shown, the second mobile communication device 10b that receives the divided payment approval information may also delete the received virtual payment information.

Although the payment service apparatus 30 delivers the created virtual payment information to the first mobile communication device 10a through the second mobile communication device 10b in the divided payment method according to this embodiment, this is exemplary only and not to be construed as a limitation. For example, the payment service apparatus 30 may directly deliver the created virtual payment information to the first mobile communication device 10a.

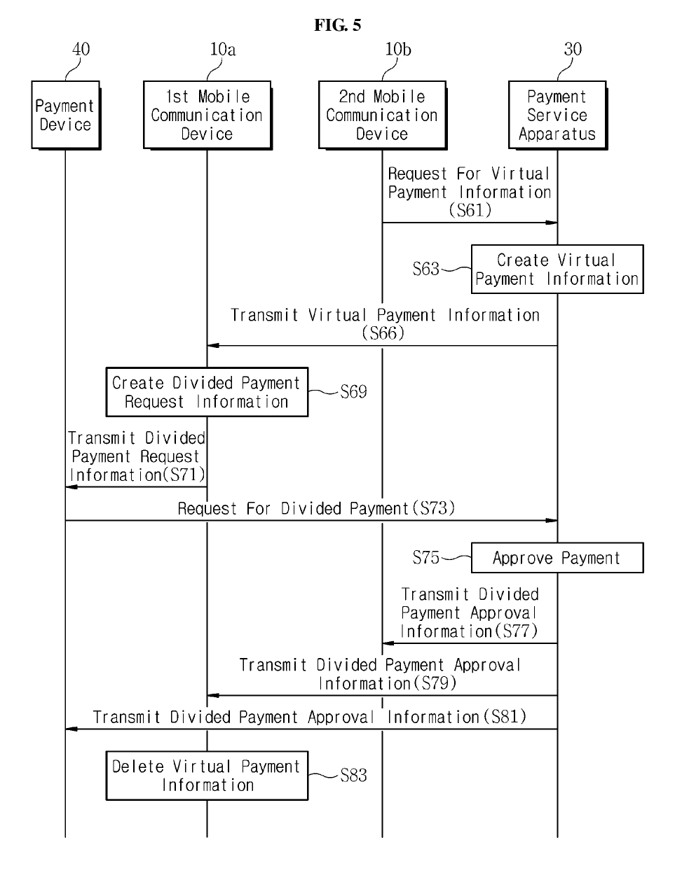

Now, a divided payment method according to another embodiment of this invention will be described with reference to FIGS. 1, 2, 3 and 5. FIG. 5 is a flow diagram illustrating a divided payment method according to another embodiment of the present invention.

At the outset, at step S61, the second mobile communication device 10brequests the payment service apparatus 30 to transmit virtual payment information of the second mobile communication device to the first mobile communication device 10a through the communication network 50. At this step, request information may contain actual payment information stored in the second mobile communication device 10b, a phone number of the first mobile communication device 10a, and a phone number of the second mobile communication device 10b.

Next, at step S63, the payment service apparatus 30 creates virtual payment information, based on the received actual payment information of the second mobile communication device 10b.

Next, at step S66, the payment service apparatus 30 transmits the virtual payment information, which is created using a phone number of the first mobile communication device 10a received from the second mobile communication device 10b, to the first mobile communication device 10a through the communication network 50. At this step, the payment service apparatus 30 may also transmit a phone number of the second mobile communication device 10b together with the virtual payment information.

At this step, the payment service apparatus 30 may notify, through a text message, etc., the second mobile communication device 10b that virtual payment information is delivered to the first mobile communication device 10a.

The following steps S69 to S83 are similar to those of FIG. 3, so that a detailed description thereof will be omitted.

The divided payment method of the present invention can be implemented in the form of program commands executable by a variety of computer means, and recorded on a computer-readable recording medium. The computer-readable recording medium can include program commands, data files, data structures, etc. individually or in combination. The program commands recorded on the medium may be ones specially designed and configured for the present invention or ones known and available to those skilled in computer software. Examples of the computer-readable recording medium include magnetic media such as a hard disk, a floppy disk and a magnetic tape, optical media such as a compact disc read only memory (CD-ROM) and a digital versatile disc (DVD), magneto-optical media such as a floptical disk, and hardware devices specially configured to store and execute program commands, such as a ROM, a random access memory (RAM) and a flash memory. Examples of the program commands include high-level language codes that can be executed by a computer using an interpreter, etc., as well as machine language codes such as those produced by a compiler. The above-stated hardware devices can be configured to operate as one or more software modules to perform the operation of the present invention, and vice versa.

While this invention has been particularly shown and described with reference to an exemplary embodiment thereof, it will be understood by those skilled in the art that various changes in form and details may be made therein without departing from the spirit and scope of this invention as defined by the appended claims.

### INDUSTRIAL APPLICABILITY

The present invention relates to a divided payment method using mobile payment and an apparatus and system for the method. For Dutch pay in mobile payment, this invention allows divided payment for all persons participating in mobile payment even though only one person among such persons transacts payment. Therefore, any inconvenience that several persons have to wait their turns and then perform payment respectively can be relieved.

Additionally, by offering virtual payment information capable of single-use when payment information of other persons is offered to the mobile communication device of a transactor, this invention provides mobile payment technique capable of removing danger of misuse due to offering payment information to other person.

1. A mobile communication device comprising:
a communication unit configured to perform communication with at least one another mobile communication device, a payment service apparatus, or a payment device; and
a control unit configured to create divided payment request information by using own payment information and the received virtual payment information when virtual payment information of a person participating in divided payment is received from the at least one another mobile communication device or the payment service apparatus through the communication unit, and to request the divided payment by transmitting the created divided payment request information to the payment device through the communication unit.

2. The mobile communication device of claim 1, wherein the communication unit includes:
a short range communication unit configured to perform short range communication with the another mobile communication device or the payment device; and
a wired/wireless communication unit configured to perform communication with the payment service apparatus through a communication network, and
wherein the control unit is further configured to receive virtual payment information through short range communication with the another mobile communication device or from the payment service apparatus through the communication network, and to transmit the divided payment request information to the payment device through short range communication.

3. The mobile communication device of claim 1, wherein the control unit is further configured to calculate a payment amount for each individual user participating in divided payment with regard to a total payment amount, and to create divided payment request information that includes the calculated payment amount for each user, own payment information, and the received virtual payment information.

4. The mobile communication device of claim 3, wherein the control unit is further configured to calculate the payment amount for each user by equally dividing the total payment amount by the number of users participating in divided payment or according to an allotted ratio of payment amount for each user.

5. The mobile communication device of claim 3, wherein the divided payment request information further includes a phone number of the mobile communication device and a phone number of the another mobile communication device.

6. The mobile communication device of claim 1, wherein the virtual payment information is single-use payment information corresponding to actual payment information of the another mobile communication device.

7. A payment service apparatus comprising:
a service communication unit configured to perform communication with a payment device, a mobile communication device of a transactor who transacts divided payment, and at least one another mobile communication device which participates in the divided payment; and
a service control unit configured to create and deliver virtual payment information to the another mobile communication device when virtual payment request information is received from the another mobile communication device through the service communication unit, to approve divided payment by performing the divided payment according to divided payment request information when the divided payment request information including actual payment information of the mobile communication device and the virtual payment information is received from the payment device, and to transmit divided payment approval information to the payment device and a plurality of mobile communication devices participating in the divided payment.

8. A divided payment method comprising steps of:
at a mobile communication device, receiving virtual payment information of a person participating in divided payment from at least one another mobile communication device or a payment service apparatus;
at the mobile communication device, creating divided payment request information by using own payment information and the received virtual payment information; and
at the mobile communication device, requesting the divided payment by transmitting the created divided payment request information to the payment device.

9. The divided payment method of claim 8, wherein the receiving step includes:
at the another mobile communication device, requesting and receiving the virtual payment information from the payment service apparatus; and
at the mobile communication device, receiving the virtual payment information from the another mobile communication device.

10. The divided payment method of claim 8, wherein the receiving step includes, at the mobile device, receiving the virtual payment information from the another mobile communication device through short range communication.

11. The divided payment method of claim 8, wherein the receiving step includes:
at the another mobile communication device, requesting the payment service apparatus to transmit the virtual payment information to the mobile communication device; and
at the mobile communication device, receiving the virtual payment information from the payment service apparatus.

12. The divided payment method of claim 11, wherein the requesting step includes, at the another mobile communication device, transmitting a phone number of the mobile communication device to the payment service apparatus, and
wherein the receiving step includes, at the payment service apparatus, transmitting the virtual payment information to the mobile communication device by using the phone number of the mobile communication device.

13. The divided payment method of claim 8, wherein the requesting step includes, at the mobile communication device, transmitting the divided payment request information to the payment device through short range communication.

14. The divided payment method of claim 8, further comprising step of:
after the requesting step, at the mobile communication device, deleting the received virtual payment information.

15. The divided payment method of claim 8, further comprising step of:
after the requesting step, at the mobile communication device, receiving divided payment approval information from the payment service apparatus.

16. The divided payment method of claim 8, further comprising step of:
after the requesting step, at the mobile communication device and the another mobile communication device, respectively receiving divided payment approval information from the payment service apparatus.

17. A computer-readable storage medium recording thereon a program for executing the divided payment method of one of claim 8.
